(19) United States
(12) Patent Application Publication
(10) Pub. No.: US 2025/0356171 A1
(43) Pub. Date: Nov. 20, 2025

(54) PERSONALIZED OUTPUT GENERATION IN GENERATIVE ARTIFICIAL INTELLIGENCE MODELS

(71) Applicant: QUALCOMM Incorporated, San Diego, CA (US)

(72) Inventors: Seokeon CHOI, Yongin-si (KR); Sunghyun PARK, Seoul (KR); Sungrack YUN, Seongnam (KR)

(21) Appl. No.: 18/959,042

(22) Filed: Nov. 25, 2024

Related U.S. Application Data
(60) Provisional application No. 63/647,473, filed on May 14, 2024.

(51) Int. Cl. G06N 3/0475; G06N 3/045; G06N 3/0499; H04N 21/854

(52) U.S. Cl. CPC G06N 3/0475; G06N 3/045; G06N 3/0499; H04N 21/854

(57) ABSTRACT

Techniques and apparatus for generating visual content according to a textual prompt input into a generative artificial intelligence model. An example method generally includes receiving an input prompt specifying a video output to be generated by a generative artificial intelligence model. Based on a spatial portion of the generative artificial intelligence model and a cross-attention map generated based on the input prompt, a spatial attention map representing a subject of the video output to be generated by the generative artificial intelligence model is generated. Based on a temporal portion of the generative artificial intelligence model and the cross-attention map, a temporal attention map representing motion to be depicted by the subject of the video output to be generated by the generative artificial intelligence model is generated. The video output is generated based on the spatial attention map and the temporal attention map, and the generated video output is output.

### CROSS-REFERENCE TO RELATED APPLICATIONS

This application claims priority to and benefit of U.S. Provisional Patent Application Ser. No. 63/647,473, entitled “Personalized Output Generation in Generative Artificial Intelligence Models,” filed May 14, 2024, and assigned to the assignee hereof, the entire contents of which are hereby incorporated by reference.

### INTRODUCTION

Aspects of the present disclosure relate to generative artificial intelligence models.

Generative artificial intelligence models can be used in various environments in order to generate a response to an input prompt (also referred to as a query or an input). For example, generative artificial intelligence models can be used in chatbot applications in which large language models (LLMs) are used to generate an answer, or at least a response, to an input prompt. Other examples in which generative artificial intelligence models can be used include a latent diffusion model, in which a model generates an image or stream of images (e.g., video content) from an input text description of the content of the desired image or stream of images, decision transformers, in which future actions are predicted based on sequences of prior actions within a given environment, or the like.

Generally, generative artificial intelligence models have many (e.g., millions or billions) of parameters, resulting in models that are large in size and incur a significant computational expense to train the model. Further, once trained, generative artificial intelligence models are often difficult (or impossible) to fine-tune, as the vast number of parameters makes overfitting (where the model fits too closely to the training data, resulting in loss of accuracy and generalization for runtime data) a major challenge (e.g., potentially relying on tremendous amounts of fine-tuning data to prevent overfitting).

To allow for generative artificial intelligence models to be fine-tuned or modified, smaller model adapters may be trained for large models. For example, adapters may be trained to improve or enable video generation based on desired appearances, movement, and the like. More generally, an adapter may allow for a machine learning model to be trained to perform tasks for which the model was not originally trained without retraining the model itself.

### BRIEF SUMMARY

Certain aspects of the present disclosure provide a method for generating visual content according to a textual prompt input into a generative artificial intelligence model. The method generally includes receiving an input prompt specifying a video output to be generated by a generative artificial intelligence model. Based on a spatial portion of the generative artificial intelligence model and a cross-attention map generated based on the input prompt, a spatial attention map representing a subject of the video output to be generated by the generative artificial intelligence model is generated. Based on a temporal portion of the generative artificial intelligence model and the cross-attention map, a temporal attention map representing motion to be depicted by the subject of the video output to be generated by the generative artificial intelligence model is generated. The video output is generated based on the spatial attention map and the temporal attention map, and the generated video output is output.

Certain aspects of the present disclosure provide a method for training a generative artificial intelligence model to generate visual content according to a textual input prompt. The method generally includes train a spatial adaptation portion of a generative artificial intelligence model based on a first training data set, the spatial adaptation portion including a cross-attention block that generates a cross-attention map separating foreground information from background information in visual content in the first training data set. A temporal adaptation portion of the generative artificial intelligence model is trained based on a second training data set, cross-attention maps generated by the spatial adaptation portion of the generative artificial intelligence model, and a frozen version of the trained spatial adaptation portion. The generative artificial intelligence model is deployed. Generally, the generative artificial intelligence model includes the trained spatial adaptation portion and the trained temporal adaptation portion.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict only certain aspects of this disclosure and are therefore not to be considered limiting of the scope of this disclosure.

FIG. 1 depicts an example workflow for video generation using a generative artificial intelligence model, according to some aspects of the present disclosure.

FIG. 2 illustrates a pipeline for training a generative artificial intelligence model including a spatial adaptation block and a temporal adaptation block to generate personalized outputs according to a text input prompt, according to aspects of the present disclosure.

FIG. 3 illustrates a pipeline for training a generative artificial intelligence model including a spatial adaptation block and a temporal adaptation block based on adaptations of image data, according to aspects of the present disclosure.

FIGS. 4A and 4B illustrate example workflows for video generation using a generative artificial intelligence model including a spatial adaptation block and a temporal adaptation block configured to generate a video output based on cross-attention masking, according to aspects of the present disclosure.

FIG. 5 illustrates example operations for generating a video output using a generative artificial intelligence model trained to generate a video output based on cross-attention masking, according to aspects of the present disclosure.

FIG. 6 illustrates example operations for training a generative artificial intelligence model to generate a video output based on cross-attention masking, according to aspects of the present disclosure.

FIG. 7 depicts an example processing system configured to perform various aspects of the present disclosure.

FIG. 8 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatus, methods, processing systems, and computer-readable mediums for generating personalized video outputs using generative artificial intelligence models.

There has been significant recent development of multi-modal generative machine learning models, such as text-to-video generation models. However, it remains highly challenging to reproduce specific objects, appearances, and/or camera or object movements based on text prompts alone. To allow generative artificial intelligence models to reproduce visual content based on a textual input prompt, some approaches use motion customization by personalizing text-to-video generation models using a few reference videos to enhance user control over video content (e.g., to allow the specification of desired motions through video inputs).

The development of diffusion models (e.g., latent diffusion models (LDMs)) has provided improvements in the text-to-video generation capabilities of machine learning models using large-scale text-video datasets. While some conventional text-to-video generation models can produce high-quality videos based on user-input text, specific information about object movements and/or camera movements in the generated videos often cannot be accurately described by text. Therefore, reproducing particular appearances or motions of objects in videos remains challenging.

To allow for the reproduction of particular motions or appearances of objects, model personalization may be used to control object and/or camera movements by allowing users to specify target motions through video inputs. A significant challenge of motion customization is to learn both visual appearance and motion appropriately by considering the disentanglement and entanglement between these factors. Although some recent approaches have tried to disentangle subject appearance and motion, some conventional techniques show substantial limitations in customizing both motions from reference videos and subject appearance from reference images for generating videos.

Certain aspects of the present disclosure provide techniques for training and inferencing generative artificial intelligence models to allow these models to understand numeracy specifications in prompts processed by these generative artificial intelligence models. To do so, a training data set may be generated based on object masking, infilling, and labeling so that base images with a number of instances of objects can result in the inclusion of related images with any number of instances of these objects, with each image labeled with the number of instances of an object included in each image. By doing so, certain aspects of the present disclosure may allow for accurate generation of images or other visual content including a correct number of instances of one or more objects as specified using generative artificial intelligence models.

### Example Video Generation Using Generative Artificial Intelligence Models

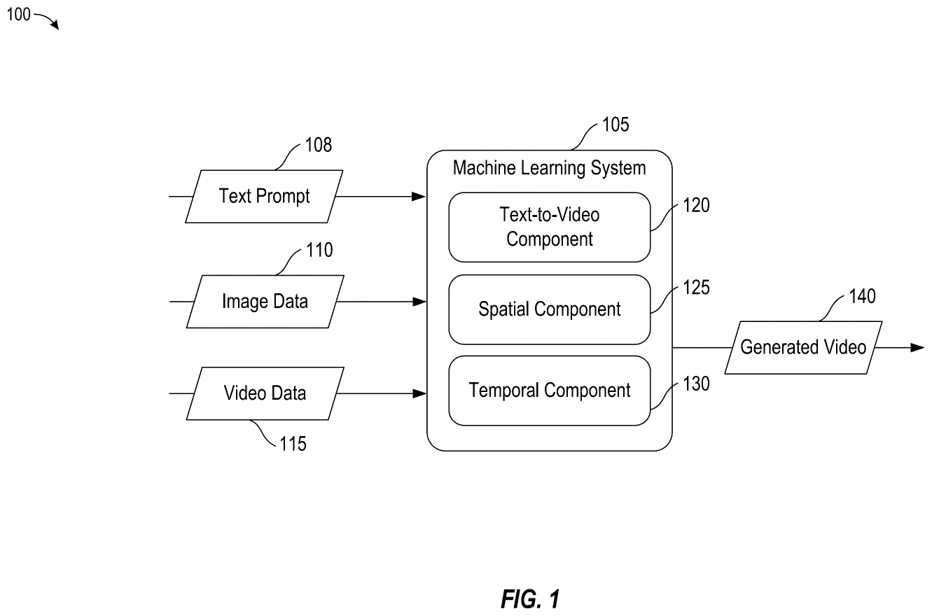

FIG. 1 depicts an example workflow 100 for video generation using generative artificial intelligence models, according to some aspects of the present disclosure. The generative artificial intelligence models described herein may be based on a video vision transformer architecture in which video data is represented by embeddings, or tokens, in the spatial and temporal domains. Details about the video vision transformer architecture may be found, for example, in Anurag Arnab et al., ViViT: A Video Vision Transformer (Nov. 1, 2021), available at https://arxiv.org/pdf/2103.15691v2.

In the illustrated example, a machine learning system 105 accesses image data 110 and video data 115 to generate one or more generated videos 140, the parameters of which may be defined by a text prompt 108 specifying, for example, subjects and subject motion to be depicted in the one or more generated videos. Although depicted as a single discrete system for conceptual clarity, in some aspects, the operations of the machine learning system 105 may be combined or distributed across any number and variety of systems. For example, in some aspects, a first computing system may be used to train or refine the model(s), while a second computing system may be used to generate video output using the trained models. As used herein, “accessing” data may generally include receiving, requesting, retrieving, obtaining, generating, collecting, or otherwise gaining access to the data. For example, the machine learning system 105 may receive the image data 110 and video data 115 from a user and/or a database or other repository (e.g., available via the Internet). In some aspects, the image data 110 may be provided to indicate the desired appearance of one or more objects in the generated video 140, while the video data 115 may be provided to indicate the desired motion of the object(s) in the generated video.

For example, in some aspects, the image data 110 may include one or more images of a man in a gorilla suit (along with a text prompt such as “a man in a gorilla suit”) to fine-tune the generation model based on the appearance of a man in a gorilla suit, as discussed in more detail below. Further, the video data 115 may include one or more videos (e.g., sequences of images) depicting a ballet dancer dancing (along with a text prompt such as “a ballet dancer is dancing”) to fine-tune the model based on the motion of the ballerina dancing, as discussed in more detail below. Subsequently, a text prompt 108 (such as “a man in a gorilla suit is a ballet dancer ballet dancing”) may be used as input, prompting the model to generate a generated video 140 depicting a man in a gorilla suit (with similar appearance to the man in the image data 110) performing ballet dancing (with similar motion to the dancer in the video data 115). Generally, the generated video 140 and the video data 115 each comprise a respective sequence of images (also referred to as frames in some aspects).

In the illustrated example, the machine learning system 105 includes a text-to-video component 120, a spatial component 125, and a temporal component 130. Although depicted as discrete components for conceptual clarity, the operations of the depicted components (and others not depicted) may be combined or distributed across any number of components, and may be implemented using hardware, software, or a combination of hardware and software. For example, in some aspects, the depicted components may each correspond to parameters of one or more generative artificial intelligence models (which may in reality be merged or fused to form a single model, rather than a set of models).

In some aspects, the text-to-video component 120 corresponds to or comprises a generative artificial intelligence model trained to generate video output based on text prompts 108. For example, in some aspects, the text-to-video component 120 uses a pre-trained LDM. In some aspects, the text-to-video component 120 or model may be referred to as “pre-trained” to indicate that the model is trained during a training stage, and the parameters of the model are then frozen and unchanged while further components (e.g., LoRA adapters) are trained and refined to modify the output of the model. Although the illustrated example depicts a text-to-video component 120, in some aspects, other multi-modal models may be used (e.g., to generate audio, video, and/or image data).

In some aspects, the text-to-video component 120 uses a diffusion model (e.g., an LDM) that generates samples (e.g., video output) from noise (e.g., Gaussian noise) through a denoising process using text prompts. Generally, LDMs perform an iterative denoising process in the latent space of an autoencoder (rather than in the pixel domain). That is, in some aspects, the text-to-video component 120 can generate output videos by iteratively denoising noise conditioned based on an input text prompt 108 indicating the desired characteristics of the video (e.g., “a man in a gorilla suit dancing”) until the desired image is generated.

In some aspects, as discussed above, the machine learning system 105 may train one or more additional model components to personalize the video generation based on the image data 110 and/or video data 115. For example, in the illustrated workflow 100, the machine learning system 105 may train the spatial component 125 and/or the temporal component 130 based on the image data 110 and video data 115.

In some aspects, to customize the text-to-video diffusion model (e.g., text-to-video component 120), the spatial component 125 and the temporal component 130 may each use low-rank adapters (e.g., LoRA adapters) for parameter-efficient fine-tuning (PEFT). For example, in some aspects, the text-to-video component 120 may include one or more spatial transformers (also referred to in some aspects as spatial attention blocks or components) and one or more temporal transformers (also referred to in some aspects as temporal attention blocks or components).

In the illustrated example, the spatial component 125 may correspond to one or more spatial LoRA(s) included in the spatial transformer(s) of the text-to-video component 120, and the temporal component 130 may correspond to one or more temporal LoRA(s) in the temporal transformer(s). In some aspects, the spatial component 125 may be trained using a single image (or a relatively small number of images) from the image data 110 based on a spatial loss, while the temporal component 130 may be trained based on the sequence of frames in the video data 115 using a temporal loss.

In some approaches, text-to-video models include spatial attention component(s) and temporal attention component(s) in a serial or sequential manner (e.g., where data is processed first by the spatial component(s) and then the temporal component(s), or vice versa). The inclusion of spatial and temporal attention components in a text-to-video model can improve training efficiency and disentangle motion and appearance. However, as discussed above, when fine-tuning the model for a given set of video data 115, the motion customization capability of such conventional text-to-video generation models is inadequate. For example, reliance on spatial-only and temporal-only attention structures can, when serially composed, struggle to learn motion effectively.

As discussed in further detail herein, to allow for motion customization in a generative artificial intelligence model, the spatial component 125 and the temporal component 130 may use cross-attention maps generated based on the text prompt 108 and prior maps generated during prior inferencing rounds (e.g., rounds associated with generating prior frames in the generated video 140) to separate background and foreground content and generate the generated video 140. The cross-attention maps may be used as masks in one or both of the spatial component 125 or the temporal component 130 to allow the generative artificial intelligence model executing on the machine learning system 105 to disentangle subject motion and subject appearance, with the cross-attention mask masking out the background content and allowing both the spatial component 125 and the temporal component 130 to focus on processing foreground content in generating the generated video 140 (e.g., to focus on generating a subject specified in the text prompt 108 and to cause the generated subject to move in a manner specified in the text prompt 108).

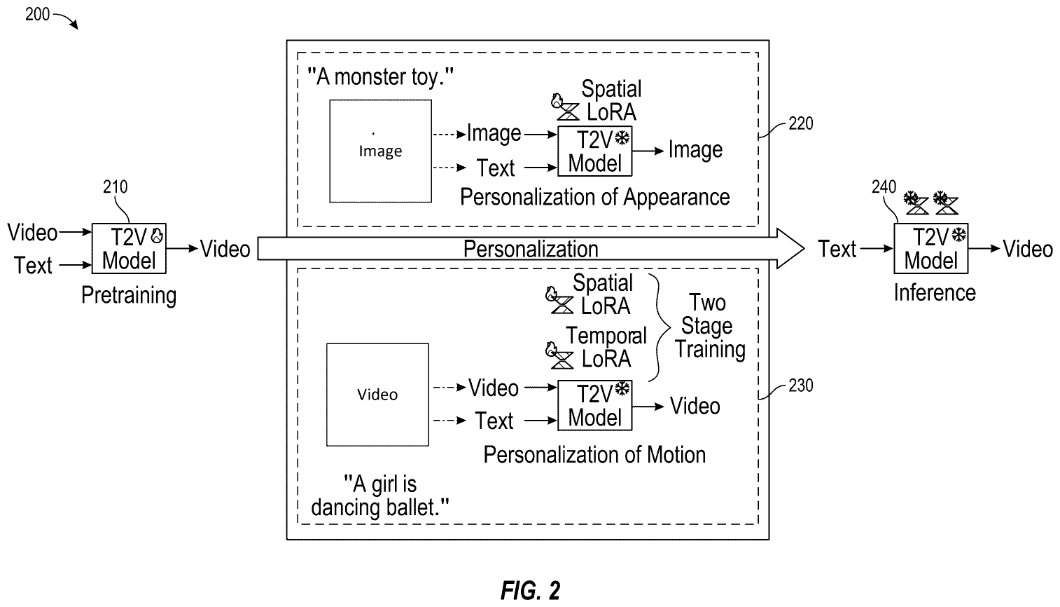

FIG. 2 illustrates a pipeline 200 for training a generative artificial intelligence model including a spatial adaptation block and a temporal adaptation block to generate personalized outputs according to a text input prompt, according to aspects of the present disclosure.

As illustrated, the pipeline 200 may begin with a pre-trained text-to-video (T2V) model 210, which may be a generative artificial intelligence model that was previously trained to generate a video output based on an input text prompt and an input video. Generally, the T2V model 210 may be trained to generate temporally consistent and photo-realistic videos from a given text prompt. However, while the T2V model 210 may generate temporally consistent and photo-realistic videos from a given text prompt, the videos may not accurately reflect what is requested in a text prompt. For example, the T2V model 210, when prompted to generate a video according to the text prompt “my dog surfing on the ocean,” the T2V model 210 may generate a video of a dog surfing on the ocean, but not a specific dog (e.g., according to an input of the user's dog). In another example, when prompted to generate a video according to the text prompt “a cartoon character performing the dab motion,” the T2V model 210 may generate a video depicting the character but may not accurately depict the motion. Further, in many cases, the content of the generated video generated by the T2V model 210 may be constrained based on backgrounds in the visual data provided as input into the T2V model 210. For example, the generated videos may depict the same background as that in the visual content fed as input into the T2V model 210, leading to a loss of background diversity when the T2V model 210 combines appearance (e.g., from images) and motion (e.g., from videos).

To allow for a generative artificial intelligence model to be customized to generate personalized videos that reflect both a desired appearance of a subject and a desired motion to be performed by the subject, the pipeline 200 may proceed with a spatial adapter training block 220 which allows for the training of a spatial adapter (illustrated as a spatial LoRA in FIG. 2) to customize the appearance of a subject in generated video content. To train the spatial adapter, a training data set of images depicting various subjects may be labeled with a textual string describing the subject(s) in images in the training data set of images. The resulting spatial adapter may thus allow a T2V model to more accurately generate visual outputs (e.g., images) depicting a subject identified in an input text string.

After training the spatial adapter in the spatial adapter training block 220, the pipeline 200 proceeds with a temporal adapter training block 230 which allows for the training of a temporal adapter (illustrated as a temporal LoRA in FIG. 2) to customize the movements of the subject in generated video content. Generally, in training the temporal adapter, the spatial adapter may be frozen. The temporal adapter may be trained based on a training data set of video content and associated textual descriptions describing the subject in the video content and the motion of the subject in the video content. By training the spatial adapter and the temporal adapter in the spatial adapter training block 220 and the temporal adapter training block 230, the pipeline 200 generates a personalized T2V model 240 from the T2V model 210.

As discussed in further detail below, the personalized T2V model 240, which includes both the spatial adapter trained in the spatial adapter training block 220 and the temporal adapter trained in the temporal adapter training block 230, can use cross-attention maps (e.g., generated by a cross-attention block) to apply masks in the spatial path and the temporal path in the personalized T2V model 240. The cross-attention map may be applied to blend feature embeddings. The cross-attention map allows for the separation of foreground and background content in the video content processed by the personalized T2V model 240, such that the model can consider both visual appearance of a subject and the motion of interest for the subject. By applying the cross-attention map to the feature embeddings, the foreground object may be emphasized, whereas the background elements may be suppressed. In some aspects, the cross-attention block may also be trained during the initial training of the T2V model 210 and/or during the personalization training of the personalized T2V model 240.

The personalized T2V model 240 may subsequently be deployed for use in generating video outputs based on text prompts specifying the appearance of a subject in the video output and a motion of the subject. During inferencing, the personalized T2V model 240 processes a textual input in a spatial path and a temporal path. In the spatial path, the personalized T2V model 240 uses the spatial adapter to customize the appearance of a subject of the video to be generated using the personalized T2V model 240. The spatial adapter can be used to customize the appearance and motion of the subject. Meanwhile, in the temporal path, the personalized T2V model 240 uses the temporal adapter to customize the motion of the subject. The resulting output may accurately reflect the appearance and motion of the subject identified in the text prompt input into the personalized T2V model 240.

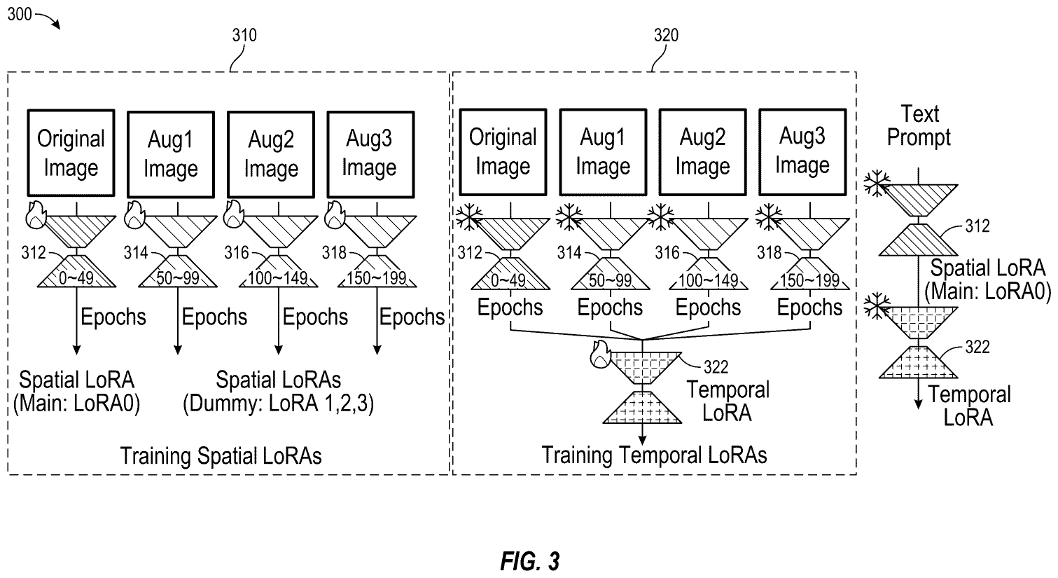

FIG. 3 illustrates a pipeline 300 for training a generative artificial intelligence model including a spatial adaptation block and a temporal adaptation block based on adaptations of image data, according to aspects of the present disclosure.

In some aspects, to further allow for the generative artificial intelligence model to effective disentangle subject appearance and subject motion, the pipeline 300 trains the spatial and temporal adaptation blocks of the generative artificial intelligence model using appearance-invariant learning techniques. Generally, as discussed above, a base training data set for training a spatial adapter may include a set of images and textual descriptions associated with the images in the base training data set (also referred to as an original training data set). In the spatial adapter training block 310, a first (base) spatial adapter 312 may be trained using the base training data set in a first set of training epochs. Subsequently, the spatial adapter training block 310 may include a plurality of phases in which “dummy” spatial adapters 314, 316, 318 (amongst others, not illustrated in FIG. 3) are trained based on training data sets adapted from the base training data set.

Generally, to generate an adapted training data set used to train one of the “dummy” spatial adapters 314, 316, 318 (amongst others), domain randomization techniques may be used to adapt the images in the base training data set from a base domain to a different domain. In some aspects, the domain randomization techniques may apply various transformations to the images in the base training data set so that the “dummy” spatial adapters 314, 316, 318 (amongst others) learn to recognize an object in an appearance-invariant manner. These transformations may include, for example, textural distortions (e.g., smoothing, sharpening, introduction of Gaussian or other random noise patterns into images, etc.), color transformations (e.g., negative color, black-and-white conversion, etc.), geometric transformations, and the like. In some aspects, the transformations applied to the base training data set to generate the adapted training data sets used to train the “dummy” spatial adapters 314, 316, 318 (amongst others) may be generated using a machine learning model that generates transformations to apply to image content using random convolution techniques.

Each “dummy” spatial adapter 314, 316, 318 may be trained using a uniquely randomized training data set. Because each “dummy” spatial adapter is trained using different types of randomization applied to the images in the base training data set, the “dummy” spatial adapters 314, 316, 318 (amongst others) trained in the spatial adapter training block 310 generally allow for the spatial adapters to learn the appearance of objects across a variety of domains. The base spatial adapter 312 and the “dummy” spatial adapters 314, 316, 318 may subsequently be used in a temporal adapter training block 320 to train a temporal adapter 322 that is insensitive, or at least less sensitive, to appearance than would be the case had only the base spatial adapter 312 been used in training the temporal adapter 322.

In the temporal adapter training block 320, the base spatial adapter 312 and the “dummy” spatial adapters 314, 316, 318 (amongst others) may be frozen (as illustrated) or learnable. The base spatial adapter 312 and the “dummy” spatial adapters 314, 316, 318 (amongst others) may be, in some aspects alternately loaded during the process of training the temporal adapter 322. For example, a different adapter selected from the set of spatial adapters including the base spatial adapter 312 and the “dummy” spatial adapters 314, 316, 318 (amongst others) may be used during each round of training using an instance of video in the training data set used to train the temporal adapter 322. In some examples, the temporal adapter used for a given round of training may be based on the equation i mod n, where i corresponds to the index of a round of training and n corresponds to the number of spatial adapters used in the temporal adapter training block 320. Thus, assuming that (as illustrated) four spatial adapters are used in training the temporal adapter 322 (e.g., n=4), the base spatial adapter 312 may be used when i mod n=0, the first “dummy” spatial adapter 314 may be used when i mod n=1, the second “dummy” spatial adapter 316 may be used when i mod n=2, and the third “dummy” spatial adapter 318 may be used when i mod n=3.

In some aspects, to train the base spatial adapter 312 and the “dummy” spatial adapters 314, 316, 318, the base spatial adapter 312 and the “dummy” spatial adapters 314, 316, 318 may each be trained using a training data set including images in the base training data set and a plurality of adapted images generated from the images in the base training data set (also referred to herein as “augmented images”). For example, an image from the base training data set may be processed using various domain randomization techniques to generate a plurality of adapted images (labeled “Aug1,” “Aug2,” and “Aug3”), and the resulting training data set may include a plurality of subsets of images. Each subset of images may include an image from the base training data set and one or more adapted images generated from the image from the base training data set. Similarly, the temporal adapter 322 may be trained using the training data set used to train the base spatial adapter 312 and the “dummy” spatial adapters 314, 316, 318. By training the base spatial adapter 312, the “dummy” spatial adapters 314, 316, 318, and the temporal adapter 322 using a training data set including base images and augmented images, certain aspects of the present disclosure may allow for the learning of object appearance-invariant and style-invariant motion information.

The resulting generative artificial intelligence model trained using the pipeline 300 may be deployed with a single spatial adapter trained during the spatial adapter training block 310 and the temporal adapter 322 trained during the temporal adapter training block 320. In some aspects, the generative artificial intelligence model may include the base spatial adapter 312 as the sole spatial adapter in the model. The “dummy” spatial adapters 314, 316, 318 (amongst others) trained during the spatial adapter training block 310 may be discarded. By doing so, the generative artificial intelligence model can be trained to generate video outputs with diverse backgrounds and may minimize, or at least reduce, the occurrence of generating video content with the incorrect subject or subject motion.

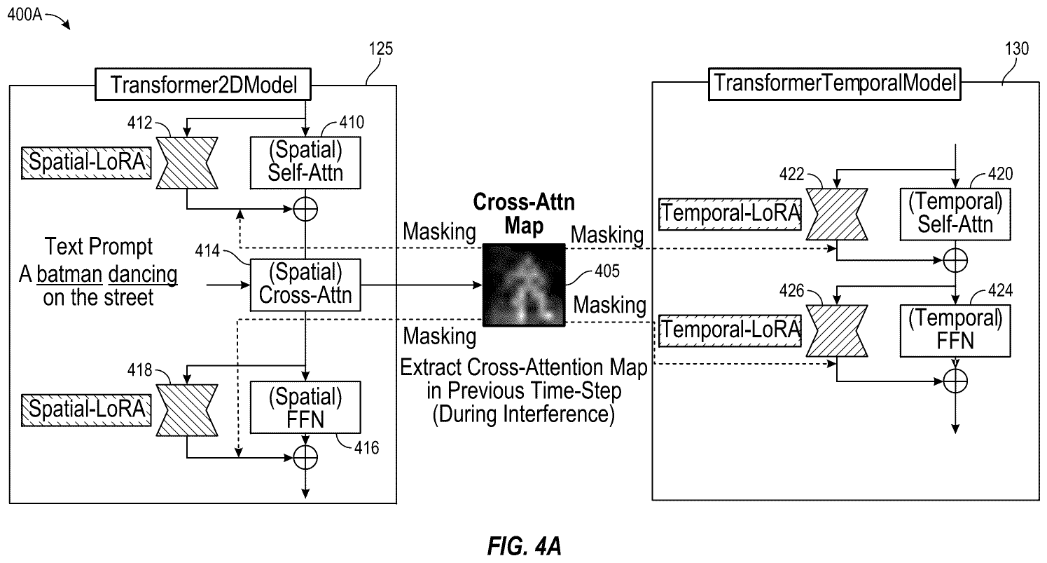

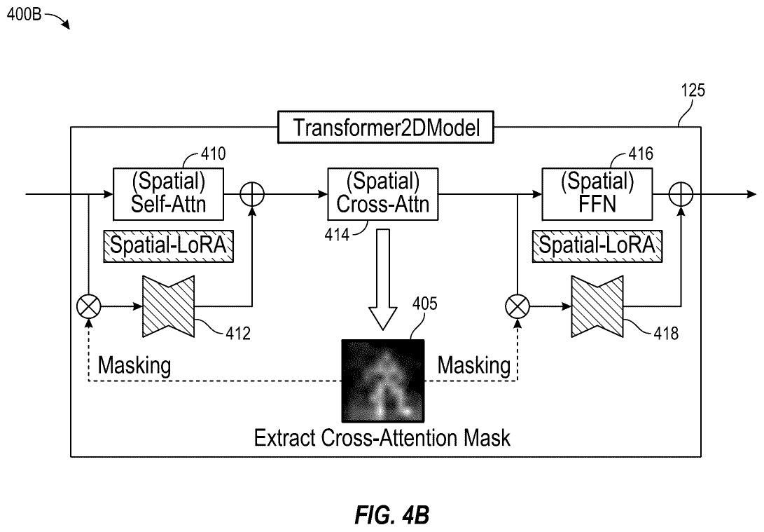

FIGS. 4A and 4B illustrate example workflows 400A and 400B for video generation using a generative artificial intelligence model including a spatial adaptation block and a temporal adaptation block configured to generate a video output based on cross-attention masking in both the spatial and temporal portions of the generative artificial intelligence model, according to aspects of the present disclosure.

In the workflow 400A, an input prompt defining a video output to be generated by a generative artificial intelligence model may be processed using a two-stage framework in which an input prompt is processed by the spatial component 125 and the temporal component 130 based on a cross-attention map 405 used to mask the generation of various attention outputs in both the spatial component 125 and the temporal component 130. Generally, as illustrated, a text prompt (e.g., the text prompt 108 illustrated in FIG. 1), may be input into a spatial cross-attention block 414 to generate the cross-attention map 405. The cross-attention map 405 generally may be generated based on an output generated in a prior round of inferencing and the text prompt, which identifies a subject to be rendered in the generated video output generated by the generative artificial intelligence model. The cross-attention map 405 may, in some aspects, be a mask that identifies areas of relevance for the spatial component 125 and the temporal component 130 and areas of less relevance for the spatial component 125 and the temporal component 130, based on the text of the input prompt. For example, the cross-attention map 405 may pass through tokens, regions in a two-dimensional space, or the like that are associated with high values (e.g., values equal to or approaching 1) in the cross-attention map 405 and may mask out tokens, regions in a two-dimensional space, or the like that are associated with low values (e.g., values equal to or approaching 0) in the cross-attention map 405.

In some aspects, the cross-attention map 405 may be generated based on normalization of values in the cross-attention map 405. For example, for a value of X, the normalized values may be defined according to the equation:

$$normalize ( X ) = \frac{X - {min}_{h , w} ( X )}{{max}_{h , w} ( X ) - {min}_{h , w} ( X )}$$

The cross-attention map 405, represented as M in the following equation, may be normalized for use according to the equation:

$$M = normalize ( sigmoid ( normalize ( {𝒜}^{k} ) - x ) )$$

where [symbol] ^{k} represents a spatial cross-attention output generated by the spatial cross-attention block 414. x may be a defined value that allows for the strength of the mask for the spatial map to be adjusted, with larger values resulting in larger spatial areas being masked and smaller values resulting in smaller spatial areas being masked.

Within the spatial component 125, a self-attention map may be generated based on an input (e.g., of prior frames generated by the generative artificial intelligence model, information about the text prompt defining the video to be generated by the generative artificial intelligence model, etc.) into a spatial self-attention block 410 and the output of a spatial adapter 412 (e.g., a spatial LoRA adapter). In some aspects, the output of the spatial self-attention block 410 may be combined with the output of the spatial adapter 412 and the cross-attention map 405 from the previous inferencing round. In some aspects, the output of the spatial adapter 412 may be masked by the cross-attention map 405 from the previous inferencing round in order to generate a masked adapter value which may be added to or otherwise combined with the output of the spatial self-attention block 410, and this combined output may serve as input into one or both of the spatial cross-attention block 414 or the spatial feedforward network 416 for processing. The masking may be performed, for example, multiplicatively, such that values in the masked adapter value are non-zero values for spatial regions of the generated video content that are relevant to the subject of the video being generated and values in the masked adapter value are zero or approximately zero values for spatial regions of the generated video content that are less relevant to the subject of the video being generated.

The output of the spatial component 125 may be the output of the spatial feedforward network 416 (e.g., a set of features generated by the feedforward network 416), modified based on a spatial adapter 418 (e.g., a spatial LoRA adapter) and the cross-attention map 405 generated based on an output of the previous inferencing round. The output of the spatial feedforward network 416 may, in some aspects, be generated based on the output of the spatial self-attention block 410 and combined based on the output of the spatial adapter 418 and the cross-attention map 405 generated based on an output of the previous inferencing round. In some aspects, the output of the spatial adapter 418 may be masked by the cross-attention map 405 generated based on an output of the previous inferencing round in order to generate a masked adapter value which may be added to or otherwise combined with the output of the spatial feedforward network 416 to generate the output of the spatial component 125.

The motion depicted by the subject of the generated video output may be generated based on the cross-attention maps 405 and inputs into the temporal component 130. To generate the temporal component and allow for motion to be introduced across frames in the generated video content that accurately reflects the motion specified in the text prompt, an input into the temporal component 430 (e.g., prior frames generated by the generative artificial intelligence model, information about the text prompt defining the video to be generated by the generative artificial intelligence model, etc.) may be processed by a temporal self-attention block 420, and a temporal adapter 422 (e.g., a temporal LoRA adapter). The output of the temporal self-attention block 420 may be combined with the output of the temporal adapter 422 and the cross-attention map 405 generated based on an output of the previous inferencing round to generate a temporal attention map which, as illustrated, may be provided as input into a temporal feedforward network 424 for projection into an output frame of the generative artificial intelligence model. In some aspects, the output of the temporal adapter 422 may be masked by the cross-attention map 405 generated based on an output of the previous inferencing round to generate a masked adapter value which may be added to or otherwise combined with the output of the temporal self-attention block 420. The masking, as discussed above, may be performed multiplicatively, such that values in the masked adapter value are non-zero values for spatial regions of the generated video content that are relevant to the subject of the video being generated and values in the masked adapter value are zero or approximately zero values for spatial regions of the generated video content that are less relevant to the subject of the video being generated.

The adapted output of the temporal self-attention block 420 may be processed by the temporal feedforward network 424 to generate a frame in the video output. Generally, the temporal feedforward network 424 may project the adapted output of the temporal self-attention block 420 into a set of tokens or other data representing pixels or other portions of a frame. In some aspects, the projected set of tokens may be modified by the output of a temporal adapter 426 (e.g., a temporal LoRA adapter) and the cross-attention map 405 generated based on an output of the previous inferencing round to adjust the content rendered in the generated frame. The output of the temporal adapter 426 and the cross-attention map 405 may be combined (e.g., multiplicatively) to allow for the addition or other combination of adapter values to the output pixels/tokens/other data generated by the temporal feedforward network 424.

In the example workflow 400B, a cross-attention map 405 may be applied to data prior to a forward pass through the spatial component 125. As illustrated, to generate a response to an input prompt defining a video output to be generated by a generative artificial intelligence model, the spatial component 125 may apply the cross-attention map 405 discussed above with respect to FIG. 4A to an input into the spatial adapter 412 and to an output of the spatial cross-attention block 414 prior to processing by the spatial adapter 418 (e.g., as masks applied to the input into the spatial adapter 412 and to the output of the spatial cross-attention block 414 prior to processing by the spatial adapter 418). In doing so, the cross-attention map 405 may be applied to the output of the spatial component 125 prior to a forward pass through the spatial adapter 412 and the spatial adapter 418, as opposed to doing so after a forward pass through the spatial adapter 412 and the spatial adapter 418 as illustrated in FIG. 4A.

### Example Operations for Training and Using Generative Artificial Intelligence Models to Generate Video Outputs Based on Cross-Attention Maps in Spatial and Temporal Adapters

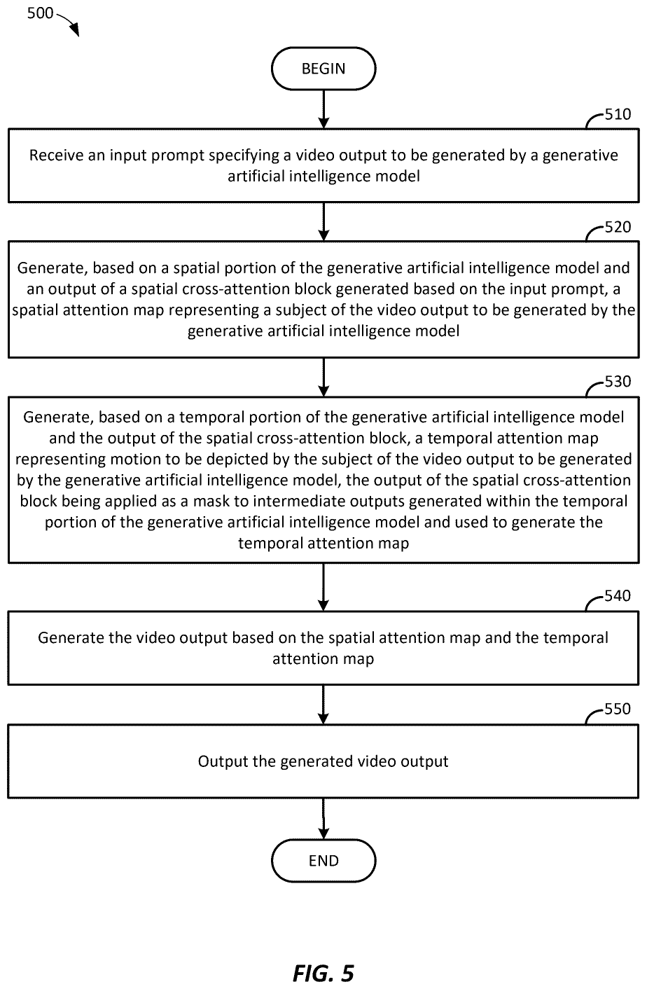

FIG. 5 illustrates example operations 500 for generating a video output using a generative artificial intelligence model trained to generate a video output based on cross-attention masking, according to aspects of the present disclosure. The operations 500 may be performed by a device on which a generative artificial intelligence model can be deployed, such as a smartphone, a tablet computer, a laptop computer, a desktop, a server, a cloud compute instance hosted in a distributed computing environment, or the like.

As illustrated, the operations 500 begin at block 510, with receiving an input prompt specifying a video output to be generated by a generative artificial intelligence model.

At block 520, the operations 500 proceed with generating, based on a spatial portion of the generative artificial intelligence model and an output of a spatial cross-attention block generated based on the input prompt, a spatial attention map representing a subject of the video output to be generated by the generative artificial intelligence model. In some aspects, the output of the spatial cross-attention block may be applied as a mask to intermediate outputs generated within the spatial portion of the generative artificial intelligence model and used to generate the spatial attention map.

In some aspects, the spatial portion of the generative artificial intelligence model includes a spatial self-attention block, a spatial-domain adaptation block, and a spatial feedforward network. The spatial self-attention block may be configured to generate a first spatial map based on the input prompt, the spatial-domain adaptation block, and a prior output of the spatial cross-attention block generated by the spatial cross-attention block during a previous inferencing round performed using the generative artificial intelligence model. The spatial cross-attention block may be configured to generate the output of the spatial cross-attention block based on the input prompt and the first spatial map. The spatial feedforward network may generate a second spatial map based on the output of the spatial cross attention block generated by the spatial cross-attention block, the prior output of the spatial cross-attention block, and the spatial-domain adaptation block.

In some aspects, the spatial-domain adaptation block comprises a first spatial adapter for an appearance of the subject and a second spatial adapter for motion of the subject.

In some aspects, the spatial portion of the generative artificial intelligence model includes a spatial self-attention block, a spatial-domain adaptation block, and a spatial feedforward network. The spatial self-attention block may be configured to generate a first spatial map based on the input prompt, a spatial-domain adaptation block, and a prior output of the spatial cross-attention block generated by the spatial cross-attention block during a previous inferencing round performed using the generative artificial intelligence model applied as a mask to an input into the spatial-domain adaptation block. The spatial cross-attention block may be configured to generate the output of the spatial cross-attention block based on the input prompt and the first spatial map. The spatial feedforward network may generate a second spatial map based on the output of the spatial cross-attention block generated by the spatial cross-attention block, the prior output of the spatial cross-attention block, and the spatial-domain adaptation block. An input into the spatial-domain adaptation block may include the output of the spatial cross-attention block masked based on the prior output of the spatial cross-attention block.

At block 530, the operations 500 proceed with generating, based on a temporal portion of the generative artificial intelligence model and the cross-attention map, a temporal attention map representing motion to be depicted by the subject of the video output to be generated by the generative artificial intelligence model.

In some aspects, the temporal portion of the generative artificial intelligence model includes a temporal self-attention block and a temporal feedforward network. The temporal self-attention block may be configured to generate a first temporal map based on a time-domain adaptation block, the prior output of the spatial cross-attention block, and the input prompt. The temporal feedforward network may be configured to generate a second temporal map based on the first temporal map, the prior output of the spatial cross-attention block, and the time-domain adaptation block.

At block 540, the operations 500 proceed with generating the video output based on the spatial attention map and the temporal attention map.

At block 550, the operations proceed with outputting the generated video output. In some aspects, outputting the generated video output includes outputting the generated video output to a display configured to display the generated video output.

In some aspects, the spatial portion of the generative artificial intelligence model is configured to customize an appearance of the subject of the video output independently of motion performed by the subject of the video output.

In some aspects, the temporal portion of the generative artificial intelligence model comprises a time-domain adaptation block for motion of the subject.

In some aspects, background content in the generated video output is different from background content in images in a training data set used to train the generative artificial intelligence model depicting one of the subject of the video output or the motion of the subject.

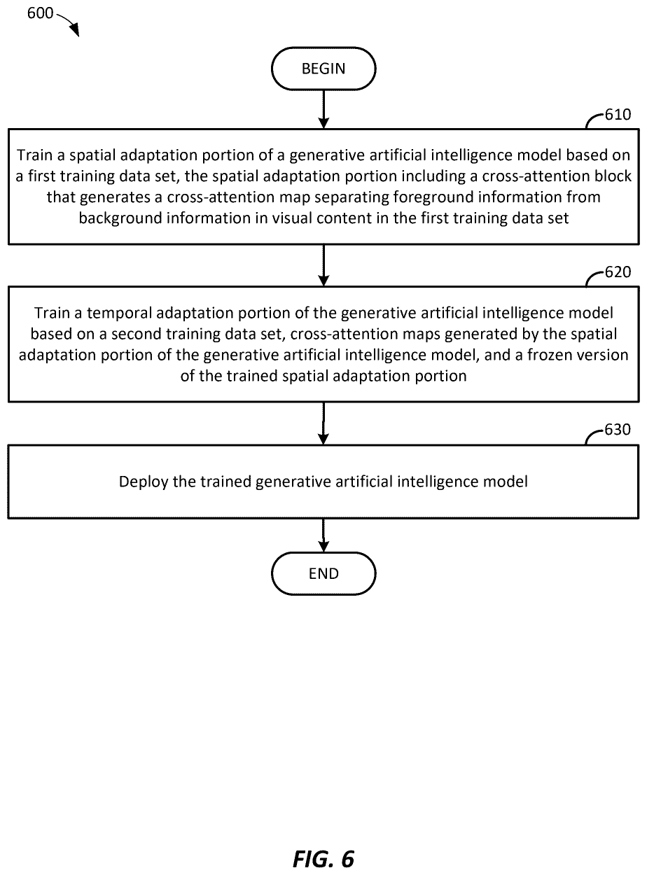

FIG. 6 illustrates example operations 600 for training a generative artificial intelligence model to generate a video output based on cross-attention masking, according to aspects of the present disclosure. The operations 600 may be performed by a device on which a generative artificial intelligence model can be trained, such as a smartphone, a tablet computer, a laptop computer, a desktop, a server, a cloud compute instance hosted in a distributed computing environment, or the like. In some aspects, the operations 600 may be performed on the same device as a device on which the operations 500 execute.

As illustrated, the operations 600 begin at block 610 with training a spatial adaptation portion of a generative artificial intelligence model based on a first training data set. The spatial adaptation portion may include a cross-attention block that generates a cross-attention map separating foreground information from background information in visual content in the first training data set.

In some aspects, the spatial adaptation portion includes an adaptation block trained to generate a spatial attention map representing a subject of a video output to be generated by the generative artificial intelligence model.

At block 620, the operations 600 proceed with training a temporal adaptation portion of the generative artificial intelligence model based on a second training data set, cross-attention maps generated by the spatial adaptation portion of the generative artificial intelligence model, and a frozen version of the trained spatial adaptation portion.

At block 630, the operations 600 proceed with deploying the generative artificial intelligence model, wherein the generative artificial intelligence model includes the trained spatial adaptation portion and the trained temporal adaptation portion.

In some aspects, training the spatial adaptation portion of the generative artificial intelligence model comprises training a plurality of spatial adaptation blocks based on one or more modifications applied to visual data in the first training data set.

In some aspects, the first training data set includes the visual data and associated textual descriptions of the images. Training the plurality of spatial adaptation blocks may include, for each respective spatial adaptation block of the plurality of spatial adaptation blocks, generating a respective adapted training data set from the plurality of images by applying one or more transformations to the visual data in the first training data set, and training the respective spatial adaptation block based on the respective adapted training data set.

In some aspects, training the temporal adaptation portion of the generative artificial intelligence model includes training a temporal adaptation block based on frozen versions of the plurality of spatial adaptation blocks.

In some aspects, deploying the generative artificial intelligence model comprises deploying one of the plurality of spatial adaptation blocks specified as a base spatial adaptation block as the spatial adaptation portion of the generative artificial intelligence model and discarding the plurality of spatial adaptation blocks other than the base spatial adaptation block.

In some aspects, the operations 600 further include capturing, via a camera, one or more images for inclusion in at least one of the first training data set or the second training data set.

### Example Processing Systems for Training and Using Generative Artificial Intelligence Models to Generate Video Outputs Based on Cross-Attention Maps in Spatial and Temporal Adapters

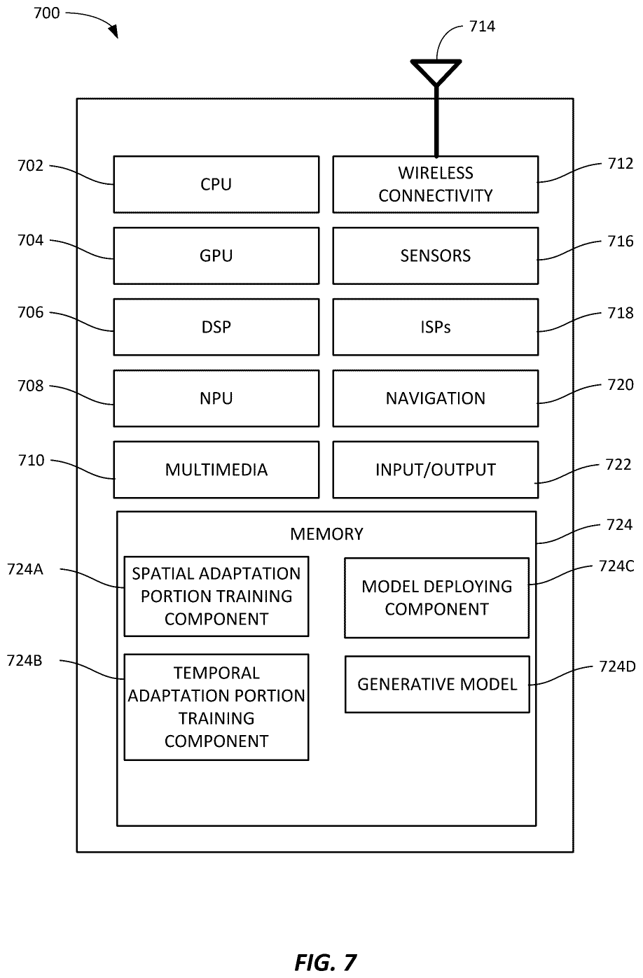

FIG. 7 depicts an example processing system 700 for training a generative artificial intelligence model to generate a video output based on cross-attention masking, such as described herein for example with respect to FIG. 6.

The processing system 700 includes a central processing unit (CPU) 702, which in some examples may be a multi-core CPU. Instructions executed at the CPU 702 may be loaded, for example, from a program memory associated with the CPU 702 or may be loaded from a memory partition (e.g., of a memory 724).

The processing system 700 also includes additional processing components tailored to specific functions, such as a graphics processing unit (GPU) 704, a digital signal processor (DSP) 706, a neural processing unit (NPU) 708, and a connectivity component 712.

An NPU, such as the NPU 708, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 708, are configured to accelerate the performance of common machine learning tasks, such as image classification, machine translation, object detection, and various other predictive models. In some examples, a plurality of NPUs may be instantiated on a single chip, such as a system on a chip (SoC), while in other examples such NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this new piece through an already trained model to generate a model output (e.g., an inference).

In some implementations, the NPU 708 is a part of one or more of the CPU 702, the GPU 704, and/or the DSP 706. These may be located on a user equipment (UE) in a wireless communication system or another computing device.

In some examples, the connectivity component 712 may include subcomponents, for example, for third generation (3G) connectivity, fourth generation (4G) connectivity (e.g., Long-Term Evolution (LTE)), fifth generation (5G) connectivity (e.g., New Radio (NR)), Wi-Fi connectivity, Bluetooth connectivity, and other wireless data transmission standards. The connectivity component 712 may be further coupled to one or more antennas 714.

The processing system 700 may also include one or more sensor processing units 716 associated with any manner of sensor, one or more image signal processors (ISPs) 718 associated with any manner of image sensor, and/or a navigation processor 720, which may include satellite-based positioning system components (e.g., GPS or GLONASS) as well as inertial positioning system components.

The processing system 700 may also include one or more input and/or output devices 722, such as screens, touch-sensitive surfaces (including touch-sensitive displays), physical buttons, speakers, microphones, and the like.

In some examples, one or more of the processors of the processing system 700 may be based on an ARM or RISC-V instruction set.

The processing system 700 also includes the memory 724, which is representative of one or more static and/or dynamic memories, such as a dynamic random access memory, a flash-based static memory, and the like. In this example, the memory 724 includes computer-executable components, which may be executed by one or more of the aforementioned processors of the processing system 700.

In particular, in this example, the memory 724 includes an a spatial adaptation portion training component 724A, a temporal adaptation portion training component 724B, a model deploying component 724C, and a generative model 724D. The depicted components, and others not depicted, may be configured to perform various aspects of the methods described herein.

Generally, the processing system 700 and/or components thereof may be configured to perform the methods described herein.

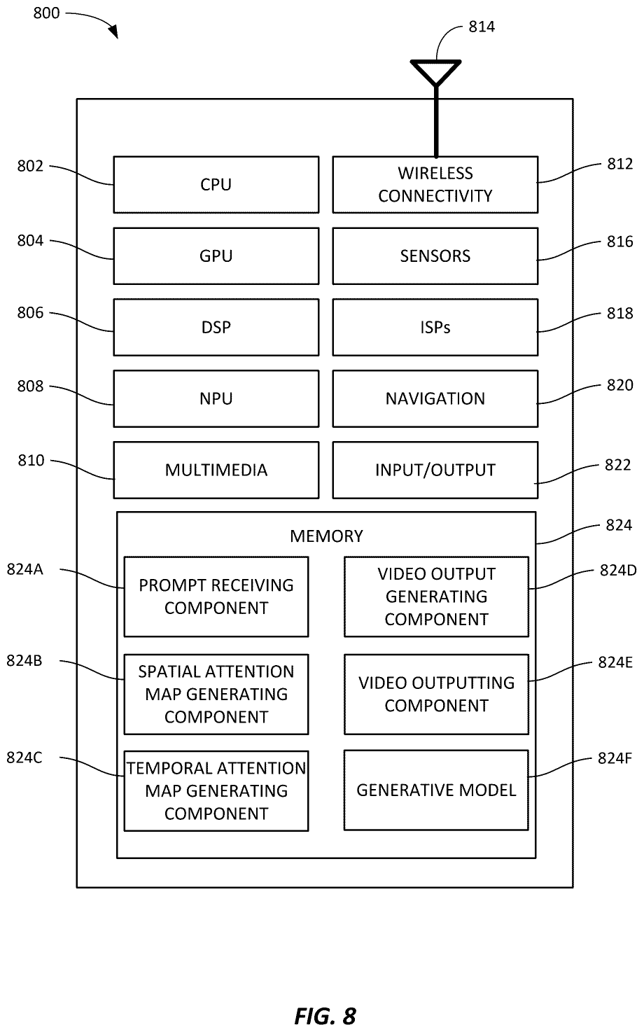

FIG. 8 depicts an example processing system 800 for generating a video output using a generative artificial intelligence model trained to generate a video output based on cross-attention masking, such as described herein for example with respect to FIG. 5.

The processing system 800 includes a central processing unit (CPU) 802, which in some examples may be a multi-core CPU. Instructions executed at the CPU 802 may be loaded, for example, from a program memory associated with the CPU 802 or may be loaded from a memory partition (e.g., of a memory 824).

The processing system 800 also includes additional processing components tailored to specific functions, such as a graphics processing unit (GPU) 804, a digital signal processor (DSP) 806, a neural processing unit (NPU) 808, and a connectivity component 812.

In some examples, the connectivity component 812 may include subcomponents, for example, for third generation (3G) connectivity, fourth generation (4G) connectivity (e.g., Long-Term Evolution (LTE)), fifth generation (5G) connectivity (e.g., New Radio (NR)), Wi-Fi connectivity, Bluetooth connectivity, and other wireless data transmission standards. The connectivity component 812 may be further coupled to one or more antennas 814.

The processing system 800 may also include one or more sensor processing units 816 associated with any manner of sensor, one or more image signal processors (ISPs) 818 associated with any manner of image sensor, and/or a navigation processor 820, which may include satellite-based positioning system components (e.g., GPS or GLONASS) as well as inertial positioning system components.

The processing system 800 may also include one or more input and/or output devices 822, such as screens, touch-sensitive surfaces (including touch-sensitive displays), physical buttons, speakers, microphones, and the like.

In some examples, one or more of the processors of the processing system 800 may be based on an ARM or RISC-V instruction set.

The processing system 800 also includes the memory 824, which is representative of one or more static and/or dynamic memories, such as a dynamic random access memory, a flash-based static memory, and the like. In this example, the memory 824 includes computer-executable components, which may be executed by one or more of the aforementioned processors of the processing system 800.

In particular, in this example, the memory 824 includes a prompt receiving component 824A, a spatial attention map generating component 824B, a temporal attention map generating component 824C, a video output generating component 824D, a video outputting component 824E, and a generative model 824F. The depicted components, and others not depicted, may be configured to perform various aspects of the methods described herein.

Generally, the processing system 800 and/or components thereof may be configured to perform the methods described herein.

### EXAMPLE CLAUSES

Implementation details of various aspects of the present disclosure are described in the following numbered clauses.

Clause 1: A processor-implemented method for machine learning, comprising: receiving an input prompt specifying a video output to be generated by a generative artificial intelligence model; generating, based on a spatial portion of the generative artificial intelligence model and an output of a spatial cross-attention block generated based on the input prompt, a spatial attention map representing a subject of the video output to be generated by the generative artificial intelligence model, the output of the spatial cross-attention block being applied as a mask to intermediate outputs generated within the spatial portion of the generative artificial intelligence model and used to generate the spatial attention map; generating, based on a temporal portion of the generative artificial intelligence model and the output of the spatial cross-attention block, a temporal attention map representing motion to be depicted by the subject of the video output to be generated by the generative artificial intelligence model, the output of the spatial cross-attention block being applied as a mask to intermediate outputs generated within the temporal portion of the generative artificial intelligence model and used to generate the temporal attention map; generating the video output based on the spatial attention map and the temporal attention map; and outputting the generated video output.

Clause 2: The method of Clause 1, wherein the spatial portion of the generative artificial intelligence model comprises: a spatial self-attention block configured to generate a first spatial map based on the input prompt, a spatial-domain adaptation block, and a prior output of the spatial cross-attention block generated by the spatial cross-attention block during a previous inferencing round performed using the generative artificial intelligence model; a spatial cross-attention block configured to generate the output of the spatial cross-attention block based on the input prompt and the first spatial map; and a spatial feedforward network configured to generate a second spatial map based on the output of the spatial cross-attention block generated by the spatial cross-attention block, the prior output of the spatial cross-attention block, and the spatial-domain adaptation block.

Clause 3: The method of Clause 2, wherein the spatial-domain adaptation block comprises a first spatial adapter for an appearance of the subject and a second spatial adapter for motion of the subject.

Clause 4: The method of any of Clauses 1 through 3, wherein the spatial portion of the generative artificial intelligence model comprises: a spatial self-attention block configured to generate a first spatial map based on the input prompt, a spatial-domain adaptation block, and a prior output of the spatial cross-attention block generated by the spatial cross-attention block during a previous inferencing round performed using the generative artificial intelligence model applied as a mask to an input into the spatial-domain adaptation block; a spatial cross-attention block configured to generate the output of the spatial cross-attention block based on the input prompt and the first spatial map; and a spatial feedforward network configured to generate a second spatial map based on the output of the spatial cross-attention block generated by the spatial cross-attention block, the prior output of the spatial cross-attention block, and the spatial-domain adaptation block, wherein an input into the spatial-domain adaptation block comprises the output of the spatial cross-attention block masked based on the prior output of the spatial cross-attention block.

Clause 5: The method of any of Clauses 1 through 4, wherein the temporal portion of the generative artificial intelligence model comprises: a temporal self-attention block configured to generate a first temporal map based on a time-domain adaptation block, the prior output of the spatial cross-attention block, and the input prompt; and a temporal feedforward network configured to generate a second temporal map based on the first temporal map, the prior output of the spatial cross-attention block, and the time-domain adaptation block.

Clause 6: The method of any of Clauses 1 through 5, wherein the spatial portion of the generative artificial intelligence model is configured to customize an appearance of the subject of the video output independently of motion performed by the subject of the video output.

Clause 7: The method of any of Clauses 1 through 6, wherein the temporal portion of the generative artificial intelligence model comprises a time-domain adaptation block for motion of the subject.

Clause 8: The method of any of Clauses 1 through 7, wherein background content in the generated video output is different from background content in images in a training data set used to train the generative artificial intelligence model depicting one of the subject of the video output or the motion of the subject.

Clause 9: The method of any of Clauses 1 through 8, wherein outputting the generated video output comprises outputting the generated video output to a display.

Clause 10: A processor-implemented method for machine learning, comprising: training a spatial adaptation portion of a generative artificial intelligence model based on a first training data set, the spatial adaptation portion including a cross-attention block that generates a cross-attention map separating foreground information from background information in visual content in the first training data set; training a temporal adaptation portion of the generative artificial intelligence model based on a second training data set, cross-attention maps generated by the spatial adaptation portion of the generative artificial intelligence model, and a frozen version of the trained spatial adaptation portion; and deploying the generative artificial intelligence model, wherein the generative artificial intelligence model includes the trained spatial adaptation portion and the trained temporal adaptation portion.

Clause 11: The method of Clause 10, wherein the spatial adaptation portion comprises an adaptation block trained to generate a spatial attention map representing a subject of a video output to be generated by the generative artificial intelligence model.

Clause 12: The method of Clause 10 or 11, wherein training the spatial adaptation portion of the generative artificial intelligence model comprises training a plurality of spatial adaptation blocks based on one or more modifications applied to visual data in the first training data set.

Clause 13: The method of Clause 12, wherein: the first training data set includes the visual data and associated textual descriptions of the images; and training the plurality of spatial adaptation blocks comprises, for each respective spatial adaptation block of the plurality of spatial adaptation blocks: generating a respective adapted training data set from the plurality of images by applying one or more transformations to the visual data in the first training data set; and training the respective spatial adaptation block based on the respective adapted training data set.

Clause 14: The method of Clause 12 or 13, wherein training the temporal adaptation portion of the generative artificial intelligence model comprises training a temporal adaptation block based on frozen versions of the plurality of spatial adaptation blocks.

Clause 15: The method of any of Clauses 12 through 14, wherein deploying the generative artificial intelligence model comprises deploying one of the plurality of spatial adaptation blocks specified as a base spatial adaptation block as the spatial adaptation portion of the generative artificial intelligence model and discarding the plurality of spatial 1 adaptation blocks other than the base spatial adaptation block.

Clause 16: The method of any of Clauses 10 through 15, further comprising capturing, via a camera, one or more images for inclusion in at least one of the first training data set or the second training data set.

Clause 17: A processing system comprising: at least one memory having executable instructions stored thereon; and one or more processors coupled to the at least one memory and configured to execute the executable instructions in order to cause the processing system to perform the operations of any of Clauses 1 through 16.

Clause 18: A processing system comprising means for performing the operations of any of Clauses 1 through 16.

Clause 19: A non-transitory computer-readable medium having executable instructions stored thereon which, when executed by one or more processors, perform the operations of any of Clauses 1 through 16.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system in a device, comprising:
a memory configured to store parameters for a generative artificial intelligence model; and
one or more processors, coupled to the memory, configured to:
receive an input prompt specifying a video output to be generated by the generative artificial intelligence model;
generate, based on a spatial portion of the generative artificial intelligence model and an output of a spatial cross-attention block generated based on the input prompt, a spatial attention map representing a subject of the video output to be generated by the generative artificial intelligence model;
generate, based on a temporal portion of the generative artificial intelligence model and the output of the spatial cross-attention block, a temporal attention map representing motion to be depicted by the subject of the video output to be generated by the generative artificial intelligence model, the output of the spatial cross-attention block being applied as a mask to intermediate outputs generated within the temporal portion of the generative artificial intelligence model and used to generate the temporal attention map;
generate the video output based on the spatial attention map and the temporal attention map; and
output the generated video output.

2. The processing system of claim 1, wherein:
the spatial cross-attention block is configured to generate the output of the spatial cross-attention block based on the input prompt and the first spatial map; and
the spatial portion of the generative artificial intelligence model comprises:
a spatial self-attention block configured to generate a first spatial map based on the input prompt, a spatial-domain adaptation block, and a prior output of the spatial cross-attention block generated by the spatial cross-attention block during a previous inferencing round performed using the generative artificial intelligence model; and
a spatial feedforward network configured to generate a second spatial map based on the output of the spatial cross-attention block, the prior output of the spatial cross-attention block, and the spatial-domain adaptation block.

3. The processing system of claim 2, wherein the spatial-domain adaptation block comprises a first spatial adapter for an appearance of the subject and a second spatial adapter for motion of the subject.

4. The processing system of claim 1, wherein:
the spatial cross-attention block is configured to generate the output of the spatial cross-attention block based on the input prompt and the first spatial map; and
the spatial portion of the generative artificial intelligence model comprises:
a spatial self-attention block configured to generate a first spatial map based on the input prompt, a spatial-domain adaptation block, and a prior output of the spatial cross-attention block generated by the spatial cross-attention block during a previous inferencing round performed using the generative artificial intelligence model applied as a mask to an input into the spatial-domain adaptation block; and
a spatial feedforward network configured to generate a second spatial map based on the output of the spatial cross-attention block generated by the spatial cross-attention block, the prior output of the spatial cross-attention block, and the spatial-domain adaptation block, wherein the input into the spatial-domain adaptation block comprises the output of the spatial cross-attention block masked based on the prior output of the spatial cross-attention block.

5. The processing system of claim 1, wherein the temporal portion of the generative artificial intelligence model comprises:
a temporal self-attention block configured to generate a first temporal map based on a time-domain adaptation block, a prior output of the spatial cross-attention block, and the input prompt; and
a temporal feedforward network configured to generate a second temporal map based on the first temporal map, the prior output of the spatial cross-attention block, and the time-domain adaptation block.

6. The processing system of claim 1, wherein the spatial portion of the generative artificial intelligence model is configured to customize an appearance of the subject of the video output independently of motion performed by the subject of the video output.

7. The processing system of claim 1, wherein the temporal portion of the generative artificial intelligence model comprises a time-domain adaptation block for motion of the subject.

8. The processing system of claim 1, wherein background content in the generated video output is different from background content in images in a training data set used to train the generative artificial intelligence model depicting one of the subject of the video output or the motion of the subject.

9. The processing system of claim 1, further comprising a display configured to display the generated video output.

10. A processor-implemented method for machine learning, comprising:
receiving an input prompt specifying a video output to be generated by a generative artificial intelligence model;
generating, based on a spatial portion of the generative artificial intelligence model and an output of a spatial cross-attention block generated based on the input prompt, a spatial attention map representing a subject of the video output to be generated by the generative artificial intelligence model;
generating, based on a temporal portion of the generative artificial intelligence model and the output of the spatial cross-attention block, a temporal attention map representing motion to be depicted by the subject of the video output to be generated by the generative artificial intelligence model, the output of the spatial cross-attention block being applied as a mask to intermediate outputs generated within the temporal portion of the generative artificial intelligence model and used to generate the temporal attention map;
generating the video output based on the spatial attention map and the temporal attention map; and
outputting the generated video output.

11. The method of claim 10, wherein:
the spatial cross-attention block is configured to generate the output of the spatial cross-attention block based on the input prompt and the first spatial map; and
the spatial portion of the generative artificial intelligence model comprises:
a spatial self-attention block configured to generate a first spatial map based on the input prompt, a spatial-domain adaptation block, and a prior output of the spatial cross-attention block generated by the spatial cross-attention block during a previous inferencing round performed using the generative artificial intelligence model; and
a spatial feedforward network configured to generate a second spatial map based on the output of the spatial cross-attention block generated by the spatial cross-attention block, the prior output of the spatial cross-attention block, and the spatial-domain adaptation block.

12. The method of claim 11, wherein the spatial-domain adaptation block comprises a first spatial adapter for an appearance of the subject and a second spatial adapter for motion of the subject.

13. The method of claim 10, wherein:
the spatial cross-attention block is configured to generate the output of the spatial cross-attention block based on the input prompt and the first spatial map; and
the spatial portion of the generative artificial intelligence model comprises:
a spatial self-attention block configured to generate a first spatial map based on the input prompt, a spatial-domain adaptation block, and a prior output of the spatial cross-attention block generated by the spatial cross-attention block during a previous inferencing round performed using the generative artificial intelligence model applied as a mask to an input into the spatial-domain adaptation block; and
a spatial feedforward network configured to generate a second spatial map based on the output of the spatial cross-attention block generated by the spatial cross-attention block, the prior output of the spatial cross-attention block, and the spatial-domain adaptation block, wherein the input into the spatial-domain adaptation block comprises the output of the spatial cross-attention block masked based on the prior output of the spatial cross-attention block.

14. The method of claim 10, wherein the temporal portion of the generative artificial intelligence model comprises:
a temporal self-attention block configured to generate a first temporal map based on a time-domain adaptation block, a prior output of the spatial cross-attention block, and the input prompt; and
a temporal feedforward network configured to generate a second temporal map based on the first temporal map, the prior output of the spatial cross-attention block, and the time-domain adaptation block.

15. The method of claim 10, wherein the spatial portion of the generative artificial intelligence model is configured to customize an appearance of the subject of the video output independently of motion performed by the subject of the video output.

16. The method of claim 10, wherein the temporal portion of the generative artificial intelligence model comprises a time-domain adaptation block for motion of the subject.

17. The method of claim 10, wherein background content in the generated video output is different from background content in images in a training data set used to train the generative artificial intelligence model depicting one of the subject of the video output or the motion of the subject.

18. A non-transitory computer-readable medium having executable instructions stored thereon, which when executed by one or more processors, cause the one or more processors to perform operations for machine learning, the operations comprising:
receiving an input prompt specifying a video output to be generated by a generative artificial intelligence model;
generating, based on a spatial portion of the generative artificial intelligence model and an output of a spatial cross-attention block generated based on the input prompt, a spatial attention map representing a subject of the video output to be generated by the generative artificial intelligence model;
generating, based on a temporal portion of the generative artificial intelligence model and the output of the spatial cross-attention block, a temporal attention map representing motion to be depicted by the subject of the video output to be generated by the generative artificial intelligence model, the output of the spatial cross-attention block being applied as a mask to intermediate outputs generated within the temporal portion of the generative artificial intelligence model and used to generate the temporal attention map;
generating the video output based on the spatial attention map and the temporal attention map; and
outputting the generated video output.

19. The non-transitory computer-readable medium of claim 18, wherein:
the spatial cross-attention block is configured to generate the output of the spatial cross-attention block based on the input prompt and the first spatial map;
the spatial portion of the generative artificial intelligence model comprises:
a spatial self-attention block configured to generate a first spatial map based on the input prompt, a spatial-domain adaptation block, and a prior output of the spatial cross-attention block generated by the spatial cross-attention block during a previous inferencing round performed using the generative artificial intelligence model; and
a spatial feedforward network configured to generate a second spatial map based on the output of the spatial cross-attention block generated by the spatial cross-attention block, the prior output of the spatial cross-attention block, and the spatial-domain adaptation block; and
the spatial-domain adaptation block comprises a first spatial adapter for an appearance of the subject and a second spatial adapter for motion of the subject.

20. The non-transitory computer-readable medium of claim 18, wherein:
the spatial cross-attention block is configured to generate the output of the spatial cross-attention block based on the input prompt and the first spatial map; and
the spatial portion of the generative artificial intelligence model comprises:
a spatial self-attention block configured to generate a first spatial map based on the input prompt, a spatial-domain adaptation block, and a prior output of the spatial cross-attention block generated by the spatial cross-attention block during a previous inferencing round performed using the generative artificial intelligence model applied as a mask to an input into the spatial-domain adaptation block; and
a spatial feedforward network configured to generate a second spatial map based on the output of the spatial cross-attention block generated by the spatial cross-attention block, the prior output of the spatial cross-attention block, and the spatial-domain adaptation block, wherein the input into the spatial-domain adaptation block comprises the output of the spatial cross-attention block masked based on the prior output of the spatial cross-attention block.
